(19) United States
(12) Patent Application Publication
(10) Pub. No.: US 2026/0356091 A1
(43) Pub. Date: Nov. 12, 2026

(54) LIQUID EJECTION APPARATUS AND LIQUID EJECTION METHOD

(71) Applicant: CANON KABUSHIKI KAISHA, Tokyo (JP)

(72) Inventor: YUSHI SUEMATSU, Kanagawa (JP)

(21) Appl. No.: 19/663,660

(22) Filed: Apr. 30, 2026

(30) Foreign Application Priority Data
May 12, 2025 (JP) 2025-079741
Nov. 27, 2025 (JP) 2025-205671

(51) Int. Cl. B41J 2/045; F24F 11/58

(52) U.S. Cl. CPC B41J 2/04563; B41J 2/04553; B41J 2/0458; B41J 2/04581; F24F 11/58; B41J 2202/08

(57) ABSTRACT

Technology of acquiring an ambient atmospheric pressure while suppressing product cost increase and resource consumption is provided. Therefore, a temperature of a print head when the print head is heated is acquired by short pulse heating control by ink ejection heaters 210 and 212 and control of a sub-heater 207. A saturated vapor pressure of ink corresponding to the acquired temperature is determined based on a relation between the saturated vapor pressure and a saturation temperature of the ink.

### BACKGROUND

### Field of the Technology

The present disclosure relates to a liquid ejection apparatus and a liquid ejection method.

### Description of the Related Art

Japanese Patent Laid-Open No. 2004-114577 discloses acquiring an ambient atmospheric pressure of an inkjet printing apparatus with a barometer or the like and correcting driving force for ejection based on atmospheric pressure information. It is disclosed that a voltage to be supplied to a heater is reduced and a duration of an electric pulse to be supplied is shortened, since the boiling point of ink is reduced at locations of high altitude and low atmospheric pressure, based on the acquired atmospheric pressure information.

However, there is a problem that newly providing a barometer as a device to acquire an ambient atmospheric pressure as in Japanese Patent Laid-Open No. 2004-114577 invites product cost increase and a rise in the base price and also leads to consumption of resources configuring the barometer.

### SUMMARY

Accordingly, the present disclosure provides technology of acquiring an ambient atmospheric pressure without requiring a special configuration by utilizing a basic configuration of an inkjet printing apparatus.

Therefore, a liquid ejection apparatus of the present disclosure includes an ejection unit that ejects liquid heated by a heating unit and a temperature acquisition unit capable of acquiring a temperature of the liquid, and further includes an atmospheric pressure determination unit that determines an ambient atmospheric pressure, and the atmospheric pressure determination unit acquires the temperature of the liquid when the ejection unit is heated by the heating unit by the temperature acquisition unit, obtains a saturated vapor pressure of the liquid corresponding to the temperature acquired by the temperature acquisition unit based on a relation between the saturated vapor pressure and a saturation temperature of the liquid, and determines the saturated vapor pressure as the atmospheric pressure of an ambient environment.

With the present disclosure, it is possible to provide technology of acquiring an ambient atmospheric pressure without requiring a special configuration by utilizing a basic configuration of an inkjet printing apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating an internal configuration of a liquid ejection apparatus;

FIG. 2A is a schematic configuration diagram illustrating a configuration of a print head;

FIG. 2B is a schematic configuration diagram illustrating the configuration of the print head;

FIG. 2C is a schematic configuration diagram illustrating the configuration of the print head;

FIG. 3 is a block diagram illustrating a control configuration of a printing apparatus;

FIG. 4 is a block diagram illustrating a flow of processing in a head temperature control circuit;

FIG. 5 is a flowchart illustrating atmospheric pressure determination processing;

FIG. 6 is a graph illustrating a transition of a head temperature T;

FIG. 7 is a flowchart illustrating a timing at which the atmospheric pressure determination processing is executed;

FIG. 8 is a flowchart illustrating printing processing;

FIG. 9 is a flowchart illustrating suction recovery processing;

FIG. 10 is a flowchart illustrating the atmospheric pressure determination processing; and

FIG. 11 is a flowchart illustrating the atmospheric pressure determination processing.

### DESCRIPTION OF THE EMBODIMENTS

### First Embodiment

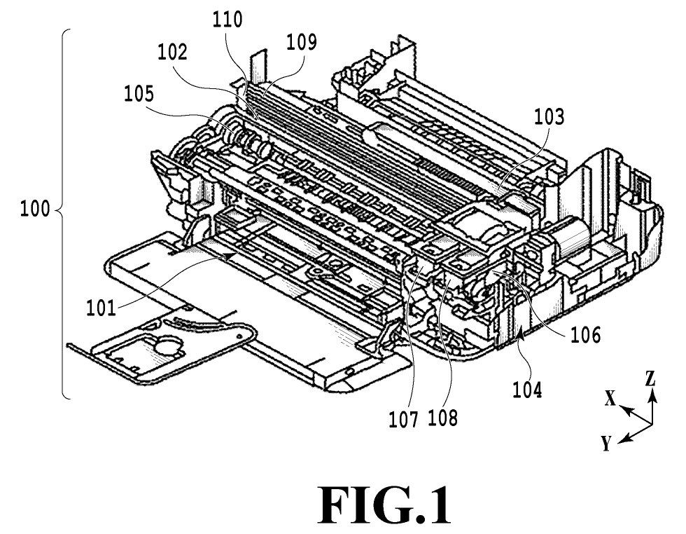

FIG. 1 is a perspective view illustrating an internal configuration of a liquid ejection apparatus 100 to which the present embodiment can be applied. The liquid ejection apparatus 100 is a printing apparatus that ejects liquid to a printing medium and performs printing. The liquid ejection apparatus (hereinafter, also referred to as a printing apparatus) 100 includes a sheet feeding section 101, a conveyance section 102, a printing section 103, and a recovery section 104. The sheet feeding section 101 feeds a printing medium into a printing apparatus body. The conveyance section 102 conveys the printing medium supplied by the sheet feeding section 101 in a Y direction (a conveyance direction). The printing section 103 prints an image on the printing medium based on image information. The recovery section 104 performs a recovery operation to maintain ink ejection performance of ejection heads (hereinafter, also referred to as print heads) 107 and 108 so as to keep quality of the image to be printed. The sheet feeding section 101 feeds the printing medium into the apparatus body.

The printing medium loaded on the sheet feeding section 101 is picked up and sent out sheet by sheet by a pickup roller and a sheet feeding roller that are not illustrated and are driven by a non-illustrated sheet feeding motor, and is fed to the conveyance section 102. A non-illustrated printing medium end detection sensor is provided upstream of a conveyance roller 105, and when a leading end of the printing medium passes through the sensor, the passing is detected. The conveyance section 102 conveys the printing medium supplied by the sheet feeding section 101. The printing medium fed to the conveyance section 102 is sandwiched by the conveyance roller 105 driven by a non-illustrated conveyance motor and a non-illustrated pinch roller, and is conveyed through the printing section 103.

The printing section 103 ejects ink onto the printing medium from the print heads 107 and 108 based on image data, and prints an image. The printing section 103 includes a carriage 106 capable of reciprocally moving in an X direction (a scanning direction) that intersects the Y direction, and the print heads 107 and 108 to be described later, that are loaded on the carriage 106. The carriage 106 is supported so as to reciprocally move in the X direction along a guide rail installed in the printing apparatus 100. The carriage 106 reciprocally moves in a printing area when performing printing on the printing medium, via a carriage belt 109 driven by a non-illustrated carriage motor. A position and a speed of the carriage 106 are detected by a non-illustrated encoder sensor loaded on the carriage 106 and an encoder scale 110 stretched in the printing apparatus, and movement of the carriage 106 is controlled based on these position and speed. When the carriage 106 moves, printing is performed on the printing medium by ejecting the ink from the print heads 107 and 108 of the printing section 103.

The printing medium is sandwiched by a non-illustrated sheet discharging roller driven synchronously with the conveyance roller 105 by the conveyance section 102 and a non-illustrated spur roller pressed by the sheet discharging roller, and is discharged to an outside of the printing apparatus. At that time, the non-illustrated printing medium end detection sensor detects, when a tail end of the printing medium passes through the sensor, the passing. The recovery section 104 includes a wiping mechanism that wipes ink droplets stuck to a surface (ejection port surface) provided with an ejection port of the print heads 107 and 108 to recover a state of the ejection port surface to a normal state. Further, the recovery section 104 includes a capping mechanism for covering the ejection port and a suction mechanism for sucking the ink from the ejection port by the capping mechanism.

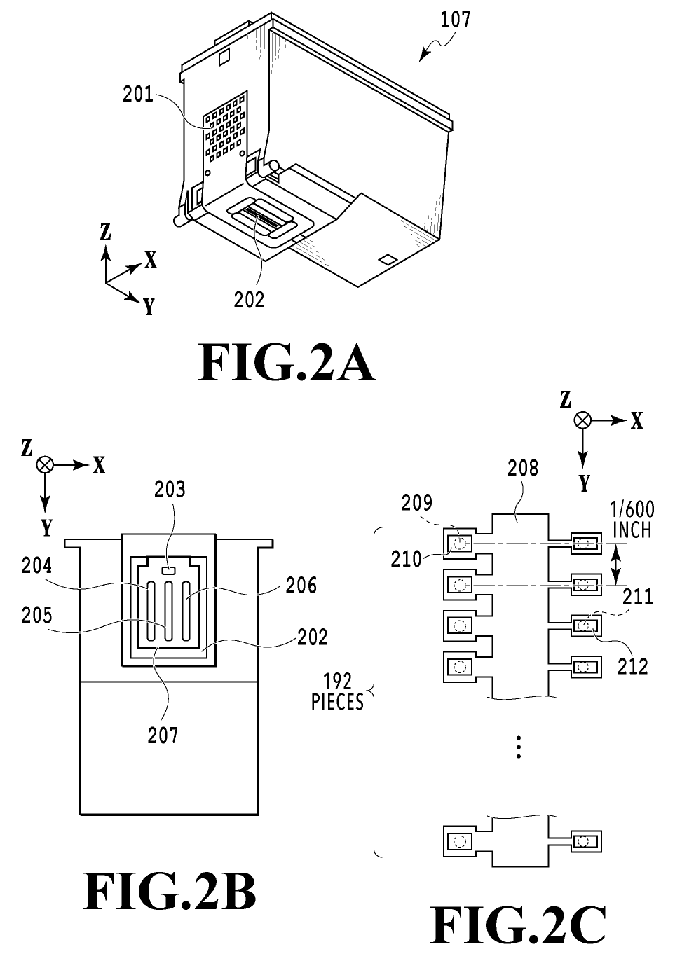

FIGS. 2A-2C are schematic configuration diagrams illustrating a configuration of the print head 107 in the present embodiment. Since the print heads 107 and 108 have a same structure, description of a configuration of the print head 108 will be omitted. FIG. 2A is a perspective view illustrating the print head 107, FIG. 2B is a bottom view illustrating the print head 107 as viewed in a Z direction, and FIG. 2C is an enlarged view illustrating an ejection port array 204 for cyan ink of the print head 107. The print head 107 is supplied with electric power required for receiving a printing signal from the printing apparatus body and driving the print head 107 via a contact pad 201. On a printing chip 202, a diode sensor 203 that detects a temperature of a print head substrate, the ejection port array 204 that ejects cyan ink, an ejection port array 205 that ejects magenta ink, and an ejection port array 206 that ejects yellow ink are disposed.

In addition, a sub-heater (heater for temperature retention) 207 for heating the ink, that is disposed in a form of surrounding the ejection port arrays 204, 205, and 206 is provided. This sub-heater 207 heats or does not heat the print head substrate and the ink depending on whether or not a voltage is applied. On both sides of an ink chamber 208, ejection ports 209 that eject 5 pl of the ink and ejection ports 211 that eject 2 pl of the ink are disposed. Directly under (on a +Z direction side of) the respective ejection ports, a 5 pl ink ejection heater 210 and a 2 pl ink ejection heater 212 are disposed respectively. The numbers of the ejection ports 209 and 211 are each 192, and an interval of the ejection ports is 1/600 inch. Therefore, the print head 107 of the present embodiment is configured such that a printed pixel density is 600 dpi.

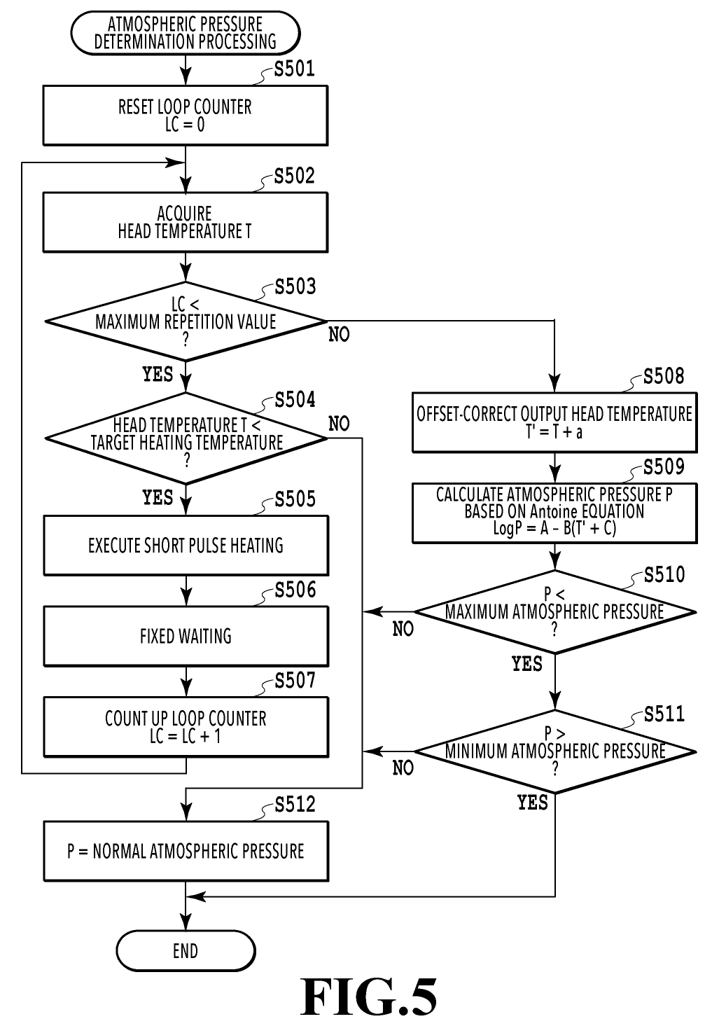

The ink ejection heaters (driving elements) 210 and 212 can retain the temperature of the ink by being supplied with a driving pulse (electric signal) that does not allow ink ejection. Hereinafter, such temperature retention control is referred to as short pulse heating control. The printing apparatus of the present embodiment adjusts the temperature of the print head substrate and the ink temperature (hereinafter, collectively a head temperature) by the short pulse heating control and control of the sub-heater 207. The printing apparatus 100 of the present embodiment adjusts the head temperature by the sub-heater 207 and the short pulse heating control, switches heating/non-heating of the print head substrate so as to approach a target temperature based on an output value of the diode sensor 203, and performs feedback control. It is same for the print head 108. The diode sensor 203 and the ink ejection heaters 210 are used in atmospheric pressure determination control in FIG. 5 to be described later.

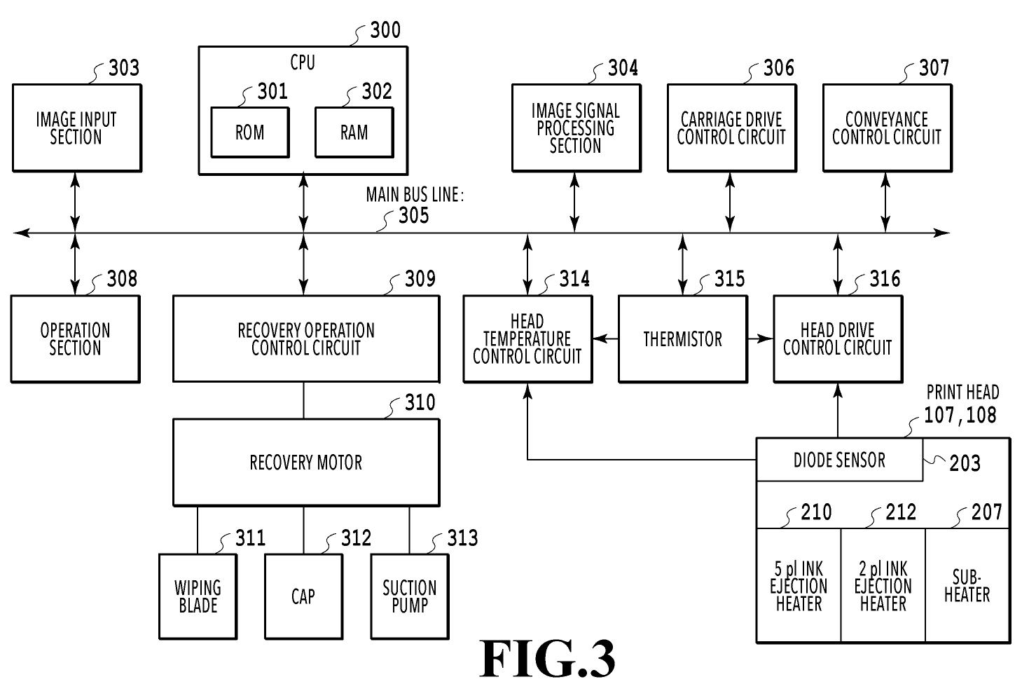

FIG. 3 is a block diagram illustrating a control configuration of the printing apparatus 100 in the present embodiment. Constituent elements of the present control configuration can be roughly classified into a software control unit and a hardware processing unit. The software control unit includes processing units such as an image input section 303, an image signal processing section 304 corresponding to it, and a CPU 300, that access a main bus line 305, respectively. In addition, the hardware processing unit includes an operation section 308, a recovery operation control circuit (recovery control section) 309, a head temperature control circuit 314, and a head drive control circuit (driving element control section) 316. Further, the hardware processing unit includes processing units such as a carriage drive control circuit 306 in a main scanning direction and a conveyance control circuit 307 in a sub scanning direction. The CPU 300 normally has a ROM 301 and a RAM 302, supplies an appropriate printing condition for input information, and drives the ink ejection heaters 210 and 212 in the print heads 107 and 108 to perform printing. Further, a program that executes a recovery timing chart of the print head is stored in advance in the ROM 301, and a recovery condition such as a preliminary ejection condition is supplied to the recovery operation control circuit 309 and the print heads 107 and 108 as needed. A recovery motor 310 drives the print heads 107 and 108 and a wiping blade 311, a cap 312, and a suction pump 313 that are opposed to and separated from the print heads 107 and 108. The head temperature control circuit 314 determines a driving condition of the sub-heater 207 on the print heads 107 and 108 based on output values of a thermistor 315 that detects an environmental temperature which is an ambient temperature of the print head and the diode sensor 203 that detects a print head temperature. Then, the head drive control circuit 316 drives the sub-heater 207 based on the determined driving condition. The head drive control circuit 316 also drives the ink ejection heaters 210 and 212 on the print heads 107 and 108. This drive of the ink ejection heaters 210 and 212 causes the print heads 107 and 108 to perform preliminary ejection, ink ejection, and ink temperature adjustment for temperature adjustment control. A program for executing the temperature adjustment control is stored in the ROM 301 for example, and makes detection of the print head temperature, the drive of the sub-heater 207, and the like be executed via the head temperature control circuit 314 and the head drive control circuit 316 or the like. Note that the head drive control circuit 316 can also perform PWM driving control by driving the ink ejection heaters 210 and 212 by a drive signal formed of a pre-pulse and a main pulse. A program of processing in FIG. 5 to be described later is stored in the ROM 301, and the processing is executed by the CPU 300.

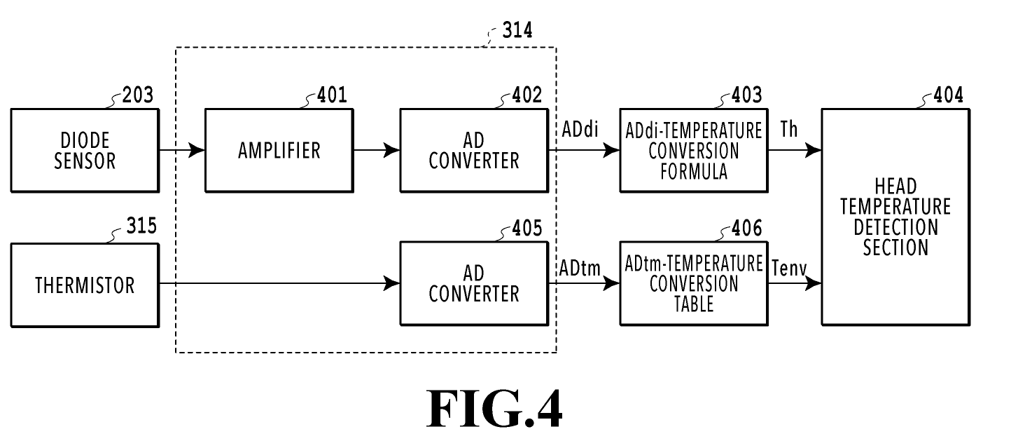

FIG. 4 is a block diagram illustrating a flow of the processing in the head temperature control circuit 314 and the processing performed on software through the ROM 301/RAM 302. When a voltage based on the print head temperature is input to the head temperature control circuit 314 from the diode sensor 203 provided in the print heads 107 and 108, a voltage value is amplified in an amplifier 401. Then, the amplified voltage value is digitalized by an AD converter 402. A digitalized diode sensor voltage value ADdi is converted to a diode temperature Th by an ADdi-temperature conversion formula 403 stored in the ROM 301. On the other hand, when a voltage based on the environmental temperature of the printing apparatus is input from the thermistor 315 to the head temperature control circuit 314, digitalization is performed by an AD converter 405. A digitalized thermistor voltage value ADtm is converted to a thermistor temperature Tenv by an ADtm-temperature conversion table 406 in the ROM 301. The diode temperature Th and the thermistor temperature Tenv obtained as above are input to a head temperature detection section 404, and are used for the control of the present disclosure.

In the present embodiment, the ejection port in the print head is considered as a hypsometer, an electric pulse that does not allow the ink ejection is supplied to the ink ejection heater 210, and an ambient atmospheric pressure is determined based on the head temperature when short pulse heating of heating the print head and the ink is repeatedly executed. Specifically, a temperature higher than a saturation temperature of liquid is defined as the target temperature, the temperature adjustment control of heating the liquid is executed, the temperature adjustment control is stopped at a point of time when a predetermined time elapses from the start of the temperature adjustment control, and a liquid temperature at the point of time is acquired. The acquired liquid temperature is defined as the saturation temperature of the liquid at the atmospheric pressure of an ambient environment, and a corresponding atmospheric pressure from a vapor pressure curve is estimated as the atmospheric pressure of the ambient environment. In the present embodiment, the liquid is ejected from the print head based on the estimated ambient atmospheric pressure to perform printing. Accordingly, the ambient atmospheric pressure can be acquired without being provided with a barometer. As a result, it is possible to estimate the ambient atmospheric pressure while avoiding cost increase and resource consumption and without depending on presence/absence of a network environment or user input accuracy.

FIG. 5 is a flowchart illustrating atmospheric pressure determination processing of considering the ejection port of the print heads 107 and 108 as a hypsometer and determining the ambient atmospheric pressure. While the present control may be executed in either one of the print heads 107 and 108, the description is given with the print head 107 as an example here. The series of processes illustrated in FIG. 5 is performed by the CPU 300 of the printing apparatus 100 expanding a program code stored in the ROM 301 in the RAM 302 and executing it. Alternatively, some or all functions in steps in FIG. 5 may be implemented by hardware such as an ASIC or an electronic circuit. Note that a symbol "S" in the description of each process means that it is a step in the flowchart. A timing at which the atmospheric pressure determination processing is executed will be described later.

When the atmospheric pressure determination processing is started, the CPU 300 initializes (resets) a loop counter in S501. In S502, a head temperature T is acquired based on the output value of the diode sensor 203 provided in the print head 107. By acquiring the head temperature T, the temperature of the ink in the print head 107 is indirectly acquired. The present step is positioned at the beginning of a loop of the short pulse heating, and the head temperature T is acquired and updated first in every loop. Thereafter, in S503, the CPU 300 refers to a value of a loop counter LC and determines whether or not to leave the heating loop depending on whether or not a maximum value has been reached. Here, the maximum value of the loop counter LC needs to be set by the number of times enough for the head temperature T to reach the saturation temperature of the ink by the short pulse heating. It is desirable to set a larger value considering that the saturation temperature of the ink changes due to the ambient atmospheric pressure certainly and that an amount of temperature rise per short pulse heating of one time changes due to variation of the ink ejection heater and the temperature of the ambient environment or the like. The processing shifts to S504 when the loop counter LC has not reached the maximum value, and the processing shifts to S508 when the loop counter LC has reached the maximum value.

In the case of shifting from S503 to S504, the CPU 300 refers to the head temperature T acquired and updated in S502, and determines whether or not the target temperature of the heating has been reached. The processing is shifted to S505 if the target temperature of the heating has not been reached, and the processing shifts to S511 if the target temperature of the heating has been reached. In the case of slow heating like the short pulse heating, since charged energy from the heater changes to latent heat associated with state change of the ink, the temperature of the ink and the head peaks at the saturation temperature of the ink as long as the ink is on the ejection heater. That is, a branch in S504 basically goes to a Yes side, and if it goes to a No side, it is estimated that an irregularity such as "there is no more ink in the ejection port" has occurred.

When the target heating temperature is set at a high temperature, there is a risk of damaging the print head. Therefore, it is desirably set at a temperature slightly higher than the saturation temperature of the ink in an atmospheric pressure range where use is assumed. In the configuration that a main component of the ink is water and the saturation temperature is roughly equal to that of water, the target heating temperature may be set to about 110°C considering that the saturation temperature of water at a normal atmospheric pressure is 100°C.

If the branch in S504 goes to Yes, the processing returns to the beginning (S502) of the loop through S505, S506, and S507. In S505, the print head is heated for a predetermined time by the short pulse heating. Thereafter, a waiting operation for the predetermined time is executed in S506, and the loop counter is counted up in S507. Waiting in S506 takes into account that noise is added to output of a temperature detection sensor by an induced current in the middle of and right after driving the ink ejection heater, and it is set to acquire the head temperature T after the waiting operation is executed.

If the branch in S504 goes to No, in S511, an ambient atmospheric pressure P is handled (adopted) as the normal atmospheric pressure considering that it is an irregular state.

In the case of shifting from S503 to S508, the head temperature T peaks near the saturation temperature of the ink at the point of time when the loop counter LC reaches the maximum value. However, depending on a position where the diode sensor 203 is disposed, the head temperature T and the ink temperature right above the heater may be slightly different. Therefore, a correction value (a) for correcting a temperature difference is stored in the ROM 301, and a corrected temperature T' is calculated by adding the correction value (a) to the head temperature T and offset-correcting the head temperature T in S508.

Thereafter, in S509, the CPU 300 substitutes the corrected temperature T' in an Antoine equation and calculates the ambient atmospheric pressure P.

By acquiring the saturation temperature of the ink, an atmospheric pressure (ambient atmospheric pressure) corresponding to the saturation temperature can be obtained. That is, the corrected temperature T' for which the head temperature T is offset-corrected is defined as the saturation temperature of the ink and the ambient atmospheric pressure P is calculated.

Here, A, B, and C are Antoine constants. The Antoine constants are the constants obtained by experimentation, and values A, B, and C are stored in the ROM 301 as the constants. For the Antoine constants, each constant may be determined by conducting an experiment using the ink, however, in the case of aqueous ink with water as the main component, sufficient accuracy for use in the control can be obtained even when the Antoine constants of water are used. The Antoine constants of water are A: 8.02754, B: 1705.616, and C: 231.405.

In S510 and S511, the CPU 300 determines whether or not the calculated ambient atmospheric pressure P is an abnormal value depending on whether or not the value is settled within a predetermined range (within a predetermined pressure range). Whether or not the ambient atmospheric pressure P is less than a maximum atmospheric pressure is determined in S510, the processing shifts to S511 if the ambient atmospheric pressure P is less than the maximum atmospheric pressure (Yes), and the processing shifts to S512 if the ambient atmospheric pressure P is not less than the maximum atmospheric pressure (No). Whether or not the ambient atmospheric pressure P is greater than a minimum atmospheric pressure is determined in S511, the processing is ended if the ambient atmospheric pressure P is greater than the minimum atmospheric pressure (Yes), and the processing shifts to S512 if the ambient atmospheric pressure P is not greater than the minimum atmospheric pressure (No).

At 1 atmospheric pressure (1013 hPa), water boils at 100°C (the saturation temperature is 100°C). In contrast, while an altitude of the mountaintop of Mt. Fuji is 3776 m, the atmospheric pressure at 3776 m is roughly 0.6 atmospheric pressure (650 hPa), and the corresponding saturation temperature of water is about 88°C. As a highest permanent residential area in the world, La Rinconada which is a city in Peru is known. La Rinconada is located at the altitude of 5100 m, the corresponding atmospheric pressure is roughly 560 hPa, and the corresponding saturation temperature of water is about 84°C. At the altitude of 8000 m where it is assumed that humans cannot adapt, the atmospheric pressure is roughly 380 hPa, and the corresponding saturation temperature of water is about 77°C.

Considering these facts, by setting the minimum atmospheric pressure at several hundred hPa, a sufficient effect can be obtained. When the ejection heater is broken or the like, the loop counter LC may reach the maximum value while the head temperature T does not rise at all. However, within the atmospheric pressure range where the use of the printing apparatus is assumed, since the saturation temperature of water is around 80°C at the lowest, even when the minimum atmospheric pressure is set at several hundred hPa, the abnormal value can be correctly determined. The value of the maximum atmospheric pressure does not need to be set at a very large value considering a use environment of an inkjet printing apparatus. It is sufficient when it is set at the saturation temperature of the ink corresponding to the target heating temperature at most. In S512, the ambient atmospheric pressure P is defined as the normal atmospheric pressure and the processing is ended. The determined ambient atmospheric pressure is stored in the RAM 302 as ambient atmospheric pressure information.

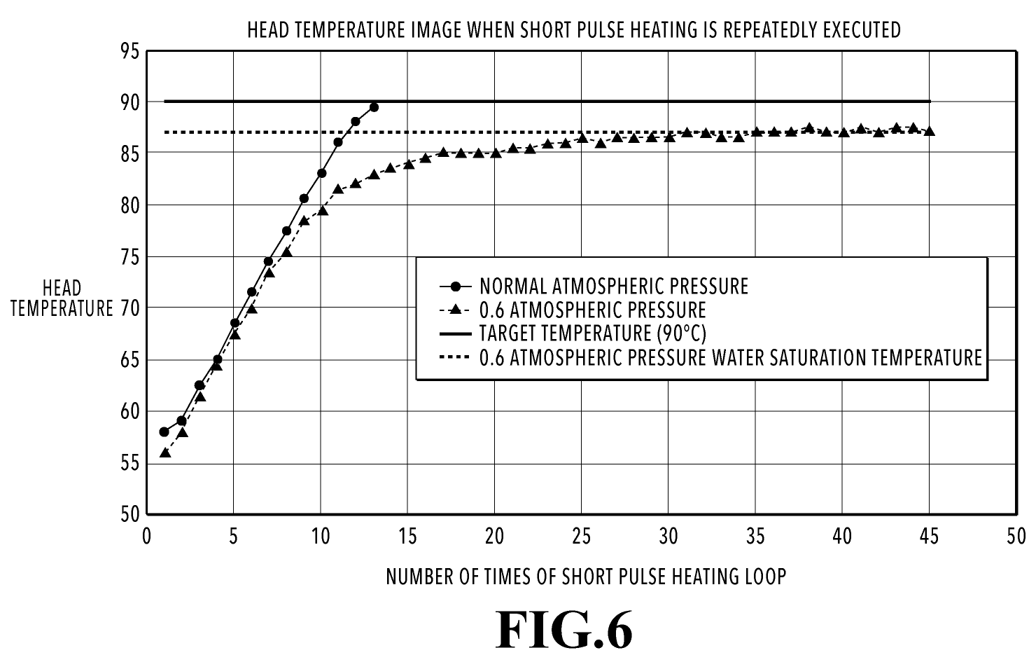

FIG. 6 is a graph illustrating a transition of the head temperature T at the normal atmospheric pressure (1 atmospheric pressure) and at 0.6 atmospheric pressure when the short pulse heating is executed with the target heating temperature set at 90°C. A horizontal axis indicates the number of times of the short pulse heating loop, and a vertical axis indicates the head temperature. When the heating is started from the head temperature T around 55°C, the head temperature T reaches 90°C that is the target heating temperature in about 13 loops at the normal atmospheric pressure. In contrast, at 0.6 atmospheric pressure, the target heating temperature (90°C) cannot be reached even when the heating is repeated for 45 loops. The saturation temperature of water at 0.6 atmospheric pressure is about 87°C, and even when the short pulse heating is repeatedly executed at 0.6 atmospheric pressure, it is recognized that the head temperature gradually approaches and peaks near 87°C since the charged energy is consumed due to the state change of the ink.

While the short pulse heating is performed with the target heating temperature set at 90°C in FIG. 6, the target heating temperature is not the temperature to be a direct target in the processing in FIG. 5. The "target heating temperature" may not be reached in the processing in FIG. 5. The atmospheric pressure at that time is determined without reaching the "target heating temperature" depending on the atmospheric pressure at that time.

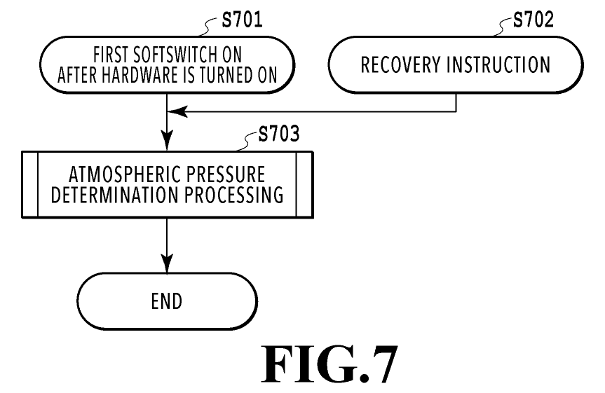

FIG. 7 is a flowchart illustrating a timing at which the atmospheric pressure determination processing is executed. When the atmospheric pressure determination processing is executed, evaporation of the ink slightly advances and downtime during which a printing operation cannot be performed is generated so that it is not recommended to increase frequency. Examples of a case where the atmospheric pressure around the printing apparatus greatly changes include a case where an installation location and a using location of the printing apparatus greatly change. When the installation location of the printing apparatus greatly changes, it is unlikely that it is moved while an electric power source is in an ON state and it is assumed that it is carried after a power supply cable is pulled out.

In S701, such a case is assumed and the atmospheric pressure determination processing is executed with a first softswitch ON as a trigger after hardware is turned ON, that is, after the printing apparatus 100 is connected to the electric power source. In addition, in the case where the installation location of the printing apparatus 100 greatly changes while the electric power source is in the ON state, it is conceivable that a trouble is generated in the image as a result of performing an ejection drive operation inappropriate for the ambient atmospheric pressure. In such a case, in anticipation of a user executing a head recovery operation, the atmospheric pressure determination processing is executed with a recovery operation instruction as a trigger as in S702. Although it depends on the configuration of the printing apparatus 100 and strength of the recovery operation, a pump is often used for recovery. It is also an advantage of using the recovery operation instruction as a trigger that capacity of a suction pump is greatly affected by the atmospheric pressure.

The atmospheric pressure determination processing in S703 is performed at such a timing. The atmospheric pressure determination processing in S703 is the atmospheric pressure determination processing described in FIG. 5.

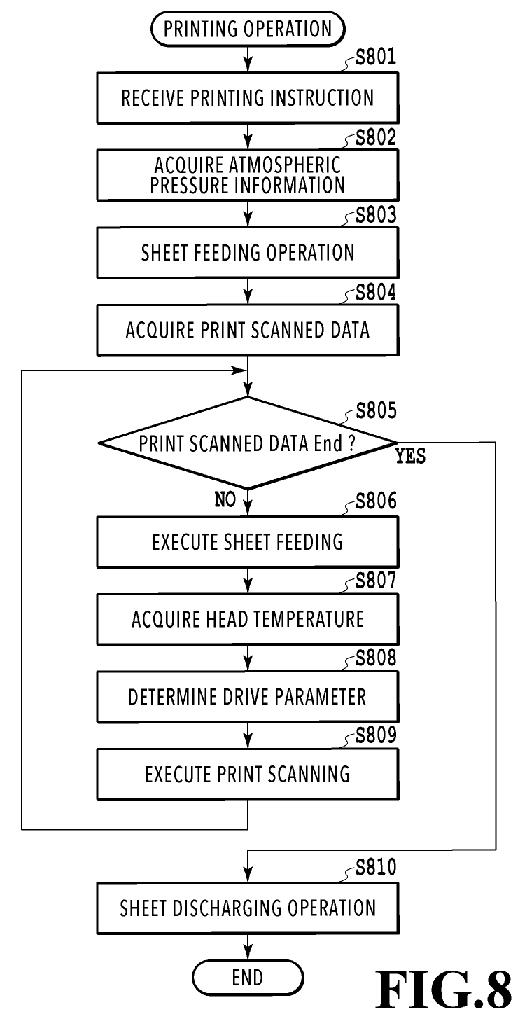

FIG. 8 is a flowchart illustrating the printing operation (ejection operation) reflecting acquired atmospheric pressure information in the present embodiment. The series of processes illustrated in FIG. 8 is performed by the CPU 300 of the printing apparatus 100 expanding a program code stored in the ROM 301 in the RAM 302 and executing it. Alternatively, some or all functions in steps in FIG. 8 may be implemented by hardware such as an ASIC or an electronic circuit. Note that a symbol "S" in the description of each process means that it is a step in the flowchart.

When a printing instruction (ejection instruction) is received in S801, the CPU 300 refers to and acquires the atmospheric pressure information acquired by the latest atmospheric pressure determination processing in S802. Thereafter, in S803, the CPU 300 drives the conveyance roller 105 and the non-illustrated pickup roller and executes the sheet feeding and conveying operation. Next print scanned data is acquired after the sheet feeding and conveying operation is completed or simultaneously with the sheet feeding and conveying operation in S804, and presence/absence of the next print data is determined in S805. If the next print scanned data is not present (Yes), the processing shifts to S810, the sheet is discharged, and the processing is ended. If the next print scanned data is present (No), the processing shifts to S806 and sheet feeding is executed to a printing position. The CPU 300 acquires the head temperature T after the sheet feeding is ended or simultaneously with it in S807, and determines a drive parameter based on the acquired atmospheric pressure information and temperature information in S808.

Since a boiling point of the ink becomes low in the case where the atmospheric pressure is low, when a pulse designed for optimum ejection at the normal atmospheric pressure is used as it is under a low atmospheric pressure environment, destabilization of ejection, increase in an ejection amount, fluctuation of an ejection speed, and the like are caused by excessive bubbling. Therefore, in the low atmospheric pressure environment, it is conceivable to take countermeasures such as shortening a driving pulse or reducing a drive voltage in order to reduce the charged energy as compared to the case where the ambient atmospheric pressure is higher than a predetermined value. Further, a drive timing may be shifted in order to absorb an effect of the fluctuation of the ejection speed.

Presence/absence of the excessive bubbling depends on not only the ambient atmospheric pressure but also the temperature of the print head at that point of time. Therefore, it is desirable that the drive parameter determined in S808 is determined based on both parameters of the ambient atmospheric pressure and the head temperature. Thereafter, the CPU 300 executes print scanning in S809 based on the parameter determined in S808, and repeats the processing from S805 to S809 until the end of the print scanned data.

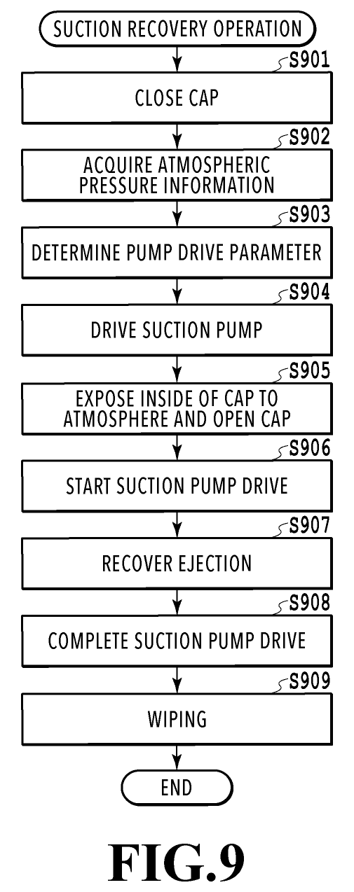

FIG. 9 is a flowchart illustrating suction recovery processing reflecting the acquired atmospheric pressure information in the present embodiment. The series of processes illustrated in FIG. 9 is performed by the CPU 300 of the printing apparatus 100 expanding a program code stored in the ROM 301 in the RAM 302 and executing it. Alternatively, some or all functions in steps in FIG. 9 may be implemented by hardware such as an ASIC or an electronic circuit. Note that a symbol "S" in the description of each process means that it is a step in the flowchart. The suction recovery processing is executed at an arbitrary timing between printing processing and printing processing or before printing processing is started. In the present embodiment, the recovery control section maintains discharge capacity by changing the number of driving times and a drive frequency of the driving element during a refreshing operation and during a suction recovery operation based on the ambient atmospheric pressure information.

When the suction recovery processing is started, the CPU 300 covers the ejection port with a cap as a preparation operation of sucking the ink from the ejection port in S901. Thereafter, the atmospheric pressure information acquired by the latest atmospheric pressure determination processing is referred to and acquired in S902, and the drive parameter of the suction pump is determined in S903. Examples of the drive parameter of the suction pump include a suction speed (drive speed), suction time (drive time), and an amount. As described above, the capacity of the suction pump is greatly affected by the atmospheric pressure. In the low atmospheric pressure environment, even when the pump is driven at the suction speed and for the suction time that are optimized for the normal atmospheric pressure environment, since the atmospheric pressure that pushes the ink in a direction of discharge by the pump is small, a flow velocity and a suction amount of the ink decrease. In the low atmospheric pressure environment, the suction amount required for recovery cannot be implemented unless the suction speed is increased or the longer suction time is taken.

The CPU 300 drives the suction pump based on the determined parameter and executes the suction in S904. Thereafter, in S905, an inside of the cap is exposed to the atmosphere and then the cap is opened. At that time, the ejection port surface is soiled with the sucked ink and the ink is accumulated inside the cap. In S906, the CPU 300 starts suction (the suction recovery operation) based on the parameter determined in S903 in order to discharge the ink accumulated inside the cap. Thereafter, in S907, color-mixed ink is discharged by ejecting the ink from the ejection port simultaneously with the suction of the ink inside the cap and performing refreshing (the refreshing operation), and stuck ink around the ejection port is suppressed from entering the ejection port by flicking the stuck ink. After discharge of the ink inside the cap is ended in S908, the ejection port surface is wiped by the wiping mechanism in S909, and the suction recovery processing is ended.

While FIGS. 8 and 9 illustrate a method of reflecting the acquired atmospheric pressure information on the operation of the liquid ejection apparatus, utilization in a field such as smart home technology or IoT, that is, reflecting on an operation of a device other than the liquid ejection apparatus, is also conceivable. In other words, the liquid ejection apparatus may be connected to a network and the ambient atmospheric pressure information of the liquid ejection apparatus may be transmitted to a different electronic device or application software through the network. Here, the application software is the software that integrally manages associated electronic devices within the same network.

For example, cooperation with an air conditioning device included in the same network as the liquid ejection apparatus is conceivable. The atmospheric pressure is closely related to weather. When the atmospheric pressure is low, an ascending air current is likely to be generated and a possibility that the weather deteriorates becomes high. When it is assumed that the ambient atmospheric pressure of the liquid ejection apparatus and the air conditioning device is low based on the acquired atmospheric pressure information, it is conceivable to take countermeasures of making the air conditioning device perform a dehumidifying operation. On the other hand, when the atmospheric pressure is high, a descending air current is generated and a possibility that the weather gets better is high. Therefore, when it is assumed that the atmospheric pressure around the liquid ejection apparatus and the air conditioning device is high, countermeasures of making the air conditioning device execute a ventilating operation and taking in outside air may be taken.

In this way, by switching the operation of the air conditioning device based on the atmospheric pressure information acquired in the liquid ejection apparatus, space comfortable for a user can be provided and an environment more suitable for the use of the liquid ejection apparatus can be arranged.

In the field of the smart home technology or IoT, it is conceivable that more electronic devices are connected to a network to cooperate. In this case, it is also conceivable that the liquid ejection apparatus and the electronic device such as the air conditioning device exchange information through integrated management software without directly exchanging the information.

Note that control of reflecting the acquired atmospheric pressure information on the operation of a device other than the liquid ejection apparatus and reflection control for the operation of the liquid ejection apparatus illustrated in FIGS. 8 and 9 may be simultaneously performed, or may be independently performed.

In this way, the temperature of the print head when the print head is heated is acquired by the short pulse heating control by the ink ejection heaters 210 and 212 and the control of the sub-heater 207. Then, based on a relation between the saturated vapor pressure and the saturation temperature of the ink, the saturated vapor pressure of the ink corresponding to the acquired temperature is determined. As a result, it is possible to provide the technology of acquiring the ambient atmospheric pressure while avoiding product cost increase and resource consumption.

### Second Embodiment

Hereinafter, the second embodiment of the present disclosure will be described with reference to the drawings. Since the basic configuration of the present embodiment is the same as that of a first embodiment, a characteristic configuration will be described below. In the first embodiment, the atmospheric pressure is determined based on the Antoine equation. While the method of determination based on the Antoine equation is the method capable of accurately obtaining an atmospheric pressure from a temperature, a method of discrete determination using a table may be also sufficient considering feedback to the control of the inkjet printing apparatus. Therefore, the present embodiment describes a method of obtaining the atmospheric pressure from the temperature using a table regarding correspondence between the saturation temperature and the saturated vapor pressure of the liquid, that is experimentally obtained in advance.

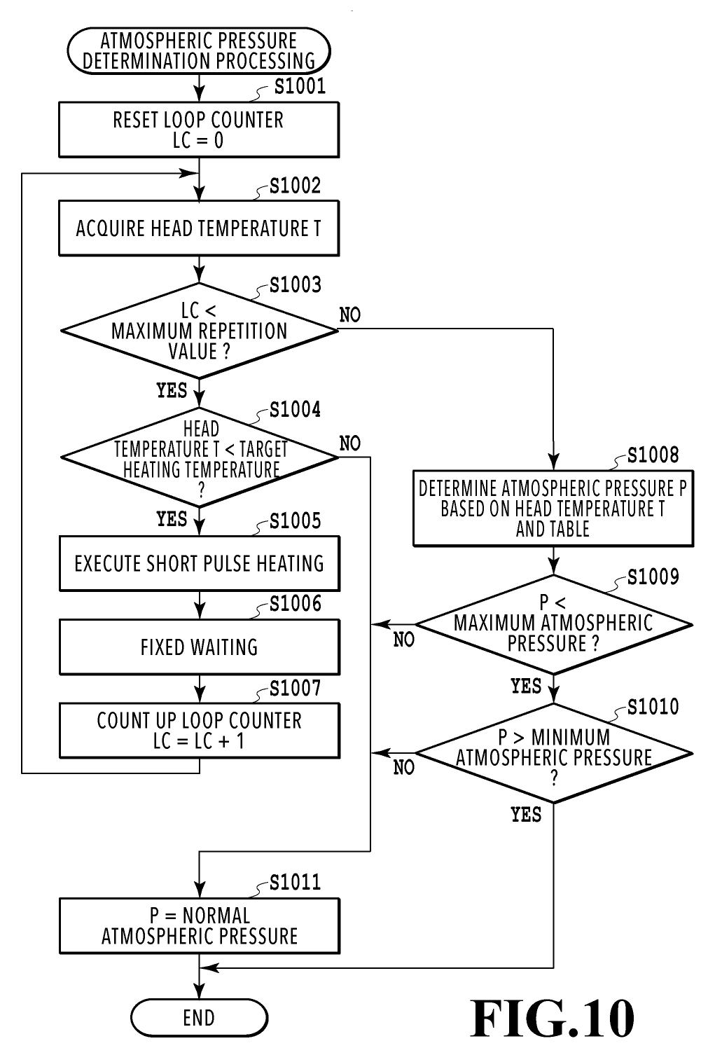

FIG. 10 is a flowchart illustrating the atmospheric pressure determination processing of determining the ambient atmospheric pressure in the present embodiment. The series of processes illustrated in FIG. 10 is performed by the CPU 300 of the printing apparatus 100 expanding a program code stored in the ROM 301 in the RAM 302 and executing it. Alternatively, some or all functions in steps in FIG. 10 may be implemented by hardware such as an ASIC or an electronic circuit. Note that a symbol "S" in the description of each process means that it is a step in the flowchart.

Since the processing other than the processing from S1008 to S1010 is the same as the processing (see FIG. 5) described in the first embodiment, the description of the processing other than the processing from S1008 to S1010 will be omitted.

In S1008, the head temperature T is collated with a table illustrated in Table 1 and stored in the ROM 301 and the corresponding atmospheric pressure P is determined. The parameter of the table may be determined based on the Antoine equation or may be determined based on an experimental value. In the present embodiment, an example of determination with the experimental value is illustrated considering incorporating temperature correction illustrated in S508 in the first embodiment. In the case of determining the atmospheric pressure based on the Antoine equation, when the head temperature is gradually approaching 100°C, the atmospheric pressure is estimated to be about 1013 hPa. However, in the present embodiment, the diode sensor 203 is in a vicinity of the ink but is not in contact with the ink. Therefore, the temperature output by the diode sensor 203 gradually approaches the temperature slightly different from the actual saturation temperature of the ink. Table 1 is an example of the parameter in the configuration that the output temperature of the diode sensor 203 gradually approaches the temperature about 1°C higher than the actual saturation temperature.

In S1009 and S1010, the CPU 300 determines whether or not the calculated ambient atmospheric pressure P is an abnormal value depending on whether or not the value is settled within the predetermined range. Whether or not the ambient atmospheric pressure P is less than the maximum atmospheric pressure is determined in S1009, the processing shifts to S1010 if the ambient atmospheric pressure P is less than the maximum atmospheric pressure (Yes), and the processing shifts to S1011 if the ambient atmospheric pressure P is not less than the maximum atmospheric pressure (No). Whether or not the ambient atmospheric pressure P is greater than the minimum atmospheric pressure is determined in S1010, the processing is ended if the ambient atmospheric pressure P is greater than the minimum atmospheric pressure (Yes), and the processing shifts to S1011 if the ambient atmospheric pressure P is not greater than the minimum atmospheric pressure (No).

For setting of the maximum atmospheric pressure and the minimum atmospheric pressure in S1009 and S1010, when a low atmospheric pressure side is little lower than 400 hPa and a high atmospheric pressure side is about 1100 hPa, almost all use cases can be covered. In particular, in the case where the heater is broken, it is considered that the head temperature T is gradually approaching the environmental temperature of the printing apparatus and it is recognized that the atmospheric pressure is abnormally low. The processing in S1010 of performing resetting at the normal atmospheric pressure in the case of getting below the minimum atmospheric pressure has an important meaning.

In such a manner, the ambient atmospheric pressure is acquired by the method of obtaining the atmospheric pressure from the temperature using the table. As a result, it is possible to provide the technology of acquiring the ambient atmospheric pressure while avoiding the product cost increase and the resource consumption.

### Third Embodiment

Hereinafter, the third embodiment of the present disclosure will be described with reference to the drawings. Since the basic configuration of the present embodiment is the same as that of the first embodiment, a characteristic configuration will be described below.

In the first embodiment and the second embodiment, the heating is continued until the loop counter reaches the maximum value. For this maximum value, it is preferable to designate the number of times for the head temperature to peak considering the temperature of the ambient environment and the heater variation or the like. However, the number of times is excessive when the temperature of the ambient environment is high or the heater is well-made (the heater variation is little or the like) or the like. Since the downtime becomes long as the number of times of the loop increases, poor usability may be felt when the heating is continued at all times until the maximum number of times of the loop is reached. Therefore, in the present embodiment, whether or not the head temperature T has peaked is determined based on a fluctuation amount of the head temperature T. Specifically, when an absolute value of a change amount of the head temperature before and after the heating continuously drops below a predetermined temperature for the predetermined number of times, the processing shifts to atmospheric pressure determination without waiting for the maximum number of the loop to be reached. Thus, it is possible to determine the atmospheric pressure without waiting for the maximum number of times of the loop to be reached.

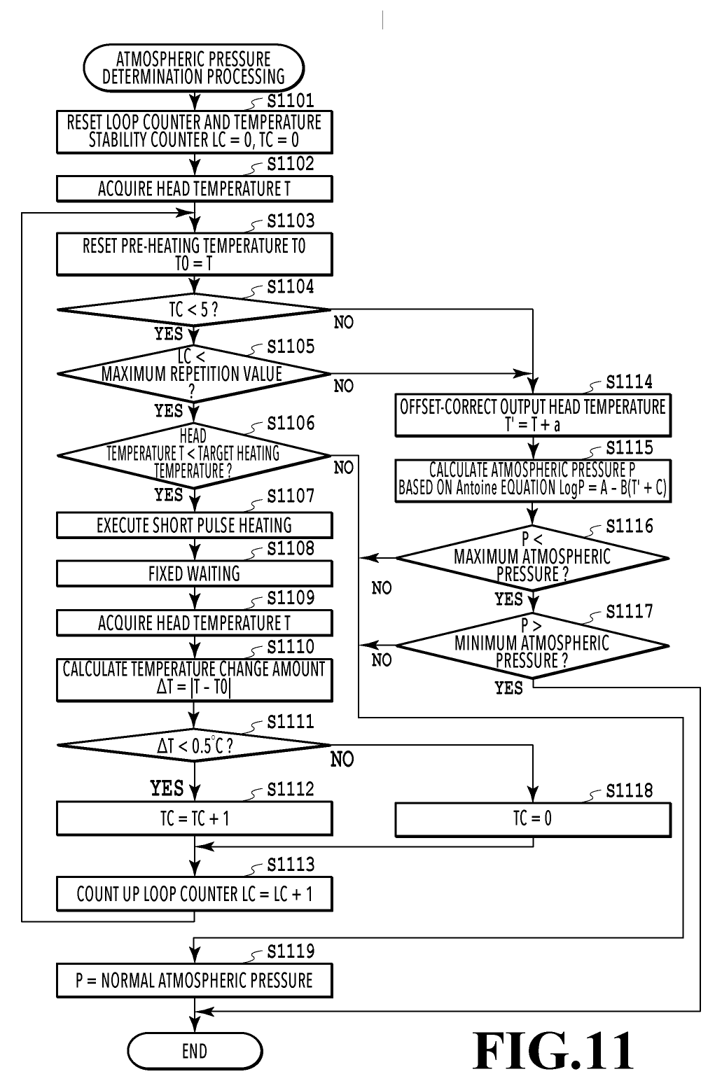

FIG. 11 is a flowchart illustrating the atmospheric pressure determination processing of determining the ambient atmospheric pressure in the present embodiment. The series of processes illustrated in FIG. 11 is performed by the CPU 300 of the printing apparatus 100 expanding a program code stored in the ROM 301 in the RAM 302 and executing it. Alternatively, some or all functions in steps in FIG. 11 may be implemented by hardware such as an ASIC or an electronic circuit. Note that a symbol "S" in the description of each process means that it is a step in the flowchart.

When the atmospheric pressure determination processing is started, in S1101, the CPU 300 initializes the loop counter LC, and also initializes a counter TC that indicates the number of continuations in the case where a temperature change amount continuously drops below a predetermined value. Thereafter, the head temperature T is acquired in S1102. By acquiring the head temperature T, the temperature of the ink in the print head 107 is indirectly acquired. Then, a pre-heating temperature T0 is reset in S1103. In S1104, the CPU 300 determines whether or not the counter TC has reached five times which is the predetermined number of times. If it has reached five times (No), it is determined that temperature change is stable and it is already near an asymptotic value and the processing shifts to S1113 leaving the loop, and if it has not reached five times (Yes), the processing shifts to S1105. Note that the predetermined number of times does not need to be limited to five times. In the case of shifting to S1105, whether or not the number of times of the loop has reached a maximum repetition value is determined. If the maximum repetition value has been reached (No), the processing shifts to S1113 leaving the loop, and if the maximum repetition value has not been reached (Yes), the processing shifts to S1106. In S1106, whether or not the head temperature T has reached the target heating temperature is determined. The processing shifts to S1119 if the target heating temperature has been reached (No), and the processing shifts to S1107 if the target heating temperature has not been reached (Yes).

The CPU 300 executes the short pulse heating in S1107, and executes waiting for the predetermined time in S1108. In S1109, the head temperature T after the heating is acquired. Thereafter, in S1110, the CPU 300 acquires an absolute value ΔT of a difference between the acquired head temperature T and the pre-heating head temperature T0. Whether or not ΔT is smaller than a predetermined value (0.5°C) is determined in S1111, the processing shifts to S1112 if it is smaller than the predetermined value (Yes), and the processing shifts to S1118 if it is not smaller than the predetermined value (No). In the case of shifting to S1112, the counter TC is counted up. In the case of shifting to S1118, the counter TC is initialized. In S1113, the CPU 300 counts up the loop counter LC and returns to S1103.

In the case of shifting from S1104 or S1105 to S1114, the CPU 300 calculates the corrected temperature T' by offset-correcting the head temperature T in S1114. Thereafter, in S1115, the CPU 300 substitutes the corrected temperature T' in the Antoine equation and calculates the ambient atmospheric pressure P.

In S1116 and S1117, the CPU 300 determines whether or not the calculated ambient atmospheric pressure P is an abnormal value depending on whether or not the value is settled within the predetermined range. Whether or not the ambient atmospheric pressure P is less than the maximum atmospheric pressure is determined in S1116, the processing shifts to S1117 if the ambient atmospheric pressure P is less than the maximum atmospheric pressure (Yes), and the processing shifts to S1119 if the ambient atmospheric pressure P is not less than the maximum atmospheric pressure (No). Whether or not the ambient atmospheric pressure P is greater than the minimum atmospheric pressure is determined in S1117, the processing is ended if the ambient atmospheric pressure P is greater than the minimum atmospheric pressure (Yes), and the processing shifts to S1119 if the ambient atmospheric pressure P is not greater than the minimum atmospheric pressure (No). In S1119, the ambient atmospheric pressure P is defined as the normal atmospheric pressure and the processing is ended.

While the ambient atmospheric pressure P is calculated by substitution in the Antoine equation in the present embodiment, the atmospheric pressure may be obtained from the temperature using the table as in the second embodiment.

In such a manner, whether or not the head temperature T has peaked is determined based on the fluctuation amount of the head temperature T, and the ambient atmospheric pressure is acquired. As a result, it is possible to provide the technology of acquiring the ambient atmospheric pressure while avoiding the product cost increase and the resource consumption.

While the ejection heater is used as a heat source of a hypsometer in the embodiments described above, it is also possible to utilize the sub-heater 207 if sufficient heating capacity can be secured. That is, the present disclosure can be applied even to a piezoelectric (piezoelectric transducer) type inkjet printing apparatus if it is provided with a temperature retention configuration.

Further, the Antoine constants, a temperature table, an offset correction value, and the like required for acquiring the atmospheric pressure information may be stored not in the ROM 301 provided in the printing apparatus but in a ROM provided in the print head. In that case, by measuring the Antoine constants and the offset correction value during a process of manufacturing the print head in a factory or the like and storing them in the ROM (storage area) of the print head, it is possible to suppress errors due to manufacturing irregularities of the print head.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Applications No. 2025-205671, filed Nov. 27, 2025, No. 2025-079741, filed May 12, 2025 which are hereby incorporated by reference herein in their entirety.

What is claimed is:

1. A liquid ejection apparatus comprising:
an ejection unit that ejects liquid heated by a heating unit; and
a temperature acquisition unit capable of acquiring a temperature of the liquid, the apparatus further comprising
an atmospheric pressure determination unit that determines an ambient atmospheric pressure, wherein
the atmospheric pressure determination unit acquires the temperature of the liquid when the ejection unit is heated by the heating unit by the temperature acquisition unit, obtains a saturated vapor pressure of the liquid corresponding to the temperature acquired by the temperature acquisition unit based on a relation between the saturated vapor pressure and a saturation temperature of the liquid, and defines the saturated vapor pressure as an atmospheric pressure of an ambient environment.

2. The liquid ejection apparatus according to claim 1, wherein the atmospheric pressure determination unit acquires the temperature of the liquid when the ejection unit is heated by the heating unit for a predetermined time by the temperature acquisition unit.

3. The liquid ejection apparatus according to claim 1, wherein the atmospheric pressure determination unit adopts the saturated vapor pressure as the ambient atmospheric pressure when fluctuation of the temperature of the liquid acquired by the temperature acquisition unit is continuously smaller than a predetermined value.

4. The liquid ejection apparatus according to claim 1, wherein the atmospheric pressure determination unit adds a predetermined offset correction value to the temperature of the liquid acquired by the temperature acquisition unit, and uses a corrected liquid temperature to determine the saturated vapor pressure of the liquid.

5. The liquid ejection apparatus according to claim 4, further comprising
a first storage area, wherein
the predetermined offset correction value is stored in the first storage area.

6. The liquid ejection apparatus according to claim 1, wherein the atmospheric pressure determination unit determines the saturated vapor pressure for the acquired temperature based on an Antoine equation and Antoine constants.

7. The liquid ejection apparatus according to claim 1, wherein the atmospheric pressure determination unit determines the saturated vapor pressure corresponding to the acquired temperature and the ambient atmospheric pressure based on a table regarding correspondence between the saturation temperature and the saturated vapor pressure of the liquid, that is experimentally obtained in advance.

8. The liquid ejection apparatus according to claim 1, wherein the atmospheric pressure determination unit sets a normal atmospheric pressure as the ambient atmospheric pressure when the determined saturated vapor pressure is larger than a first predetermined pressure.

9. The liquid ejection apparatus according to claim 8, wherein the atmospheric pressure determination unit sets a normal atmospheric pressure as the ambient atmospheric pressure when the determined saturated vapor pressure is smaller than a second predetermined pressure.

10. The liquid ejection apparatus according to claim 1, wherein the atmospheric pressure determination unit sets a normal atmospheric pressure as the ambient atmospheric pressure when the temperature of the liquid acquired by the temperature acquisition unit becomes greater than a predetermined temperature.

11. The liquid ejection apparatus according to claim 1, further comprising
a third storage area, wherein
the ambient atmospheric pressure determined by the atmospheric pressure determination unit is stored in the third storage area.

12. The liquid ejection apparatus according to claim 1, wherein determination of the atmospheric pressure by the atmospheric pressure determination unit is executed immediately after an electric power source of the liquid ejection apparatus is turned on.

13. The liquid ejection apparatus according to claim 11, further comprising:
a driving element that ejects the liquid from the ejection unit; and
a driving element control section that determines an electric signal to be applied, wherein
the driving element control section determines the electric signal to be applied to the driving element based on ambient atmospheric pressure information stored in the third storage area.

14. The liquid ejection apparatus according to claim 13, wherein the driving element is a piezoelectric element.

15. The liquid ejection apparatus according to claim 1, further comprising
a connection unit to a network, wherein
ambient atmospheric pressure information of the liquid ejection apparatus is transmitted to a different electronic device or application software through the network.

16. The liquid ejection apparatus according to claim 15, wherein the electronic device is an air conditioning device.

17. The liquid ejection apparatus according to claim 16, wherein the air conditioning device performs a dehumidifying operation when it is assumed that the ambient atmospheric pressure of the liquid ejection apparatus and the air conditioning device is low based on the transmitted atmospheric pressure information.

18. The liquid ejection apparatus according to claim 16, wherein the air conditioning device performs a ventilating operation when it is assumed that the ambient atmospheric pressure of the liquid ejection apparatus and the air conditioning device is high based on the transmitted atmospheric pressure information.

19. The liquid ejection apparatus according to claim 15, wherein the application software is software that integrally manages associated electronic devices within the same network.

20. A liquid ejection method comprising:
a step of heating an ejection unit that ejects liquid by a heating unit;
a step of acquiring a temperature of the ejection unit heated by the heating unit;
a step of correcting the acquired temperature of the ejection unit;
a step of determining an ambient atmospheric pressure from a saturated vapor pressure of the liquid corresponding to the acquired temperature based on a relation between the saturated vapor pressure and a saturation temperature of the liquid; and
a step of ejecting the liquid from the ejection unit based on the determined ambient atmospheric pressure.
